(19) United States
(12) Patent Application Publication
(10) Pub. No.: US 2014/0268681 A1
(43) Pub. Date: Sep. 18, 2014

(54) EXERCISE WRISTBAND WHICH CAN EXTEND ILLUMINATION TIME

(71) Applicants: Connie WANG, Irvine, CA (US); Wei Hung YU, New Taipei (TW)

(72) Inventors: Connie WANG, Irvine, CA (US); Wei Hung YU, New Taipei (TW)

(21) Appl. No.: 13/845,522

(22) Filed: Mar. 18, 2013

(51) Int. Cl. F21V 33/00

(52) U.S. Cl. CPC F21V 33/0076
USPC 362/103

(57) ABSTRACT

An exercise wristband that can extend illumination time, comprised of a translucent, flexible wristband and lighting unit, wherein the surface of the wristband has a 3D embossed and colored concave and convex design or text, and the underside has an insertion slot and cover. A lighting unit fits inside the insertion slot in the wristband and includes a light component, Integrated Circuit board (IC board), and a highly sensitive vibration switch.

### BACKGROUND OF THE INVENTION

1. Field of the Invention

This invention relates to a type of exercise wristband that can extend illumination time, more specifically a type of wristband which because of the extension by several seconds of the light illumination emitted in pulses with the vibration of the wristband thereby allows the special concave and convex pattern or text on the wristband others to achieve a three-dimensional (3D) visual effect, and can allow others to more easily see the user wearing the wristband, as well as see more clearly the special concave and convex pattern or text on the wristband.

2. Description of the Prior Art

The light-up exercise wristbands currently on the market largely have lighting components inside them and are activated by a switch or vibration switch. However, switch-controlled light-up wristbands emit light continuously, therefore having no special warning effect and resulting in wasted electricity; light-up wristbands activated by vibration switches light up only momentarily when the user shakes, and are therefore deficient in their warning effect.

### SUMMARY OF THE INVENTION

The purpose of this invention is to provide a kind of exercise wristband that through an extended illumination time may cause the 3D effect of the embossed structure to be even more vivid, thereby increasing the band's distinctness and improving its warning effect.

The main characteristics of the invention are a wristband, made of flexible and translucent material, the surface of which has a 3D embossed concave and convex design, and the underside of which has and insertion slot and cover; a lighting unit, fit within the insertion slot on the wristband, and which includes a light component, integrated circuit board (IC board), and highly sensitive vibration switch, wherein the light component and vibration switch are integrated on the IC board, and the IC board is design with a circuit that extends illumination time.

### BRIEF DESCRIPTION OF DRAWINGS

This invention is better understood by referring to the accompanying drawings, wherein:

FIG. 1 is a perspective view of the preferred embodiment of the exercise wristband that can extend illumination time in the present invention;

FIG. 2 is a partial section view of the preferred embodiment of the exercise wristband that can extend illumination time in the present invention;

FIG. 3 is a bottom view of the preferred embodiment of FIG. 1;

FIG. 4 is a perspective view of the exercise wristband that can extend illumination time in use in the present invention; and

FIG. 5 is a perspective view of another actual embodiment of the exercise wristband that can extend illumination time in the present invention.

### DETAILED DESCRIPTION OF THE PREFERRED EMBODIMENT

As shown in FIGS. 1 to 5, a preferred embodiment of a wristband that can extend illumination time in the present invention includes a wristband 1 and a lighting unit 2.

The wristband 1 is made of flexible and translucent material. The surface of this wristband 1 has a special three-dimensional (3D) embossed concave and convex pattern or text 10 design, and bright colors can be painted on the 3D embossed concave and convex pattern or text 10. The underside of the wristband 1 has an insertion slot 11 and cover 12 of appropriate size.

The lighting unit 2 is fits inside the insertion slot 11 on the wristband 1, with the cover 12 tightly enclosing it to prevent water leakage. The lighting unit 2 is comprised of a light component 20, Integrated Circuit board (IC board) 21, a highly sensitive vibration switch 22 and battery 23, with the light component 20 comprised of one or more light emitting diodes (LEDs). The light component 20 can serve as a light source of different colors. The IC board 21 has a circuit which extends illumination time, and which links to the light component 20 on the IC board 21. Also on the IC board 21 has a battery 23 and vibration switch 22. The vibration switch 22 is integrated with the IC board 21, with the vibration switch causing the circuit to conduct only when there is a vibration.

When the user wears the wristband 1 while exercising, the swinging of the arm (A) activates the vibration switch 22 in the wristband 1, at which time the battery 23 on the IC board 21 activates and illuminates the light component 20. Due to the illumination-extending design of the IC board 21, the flicker of light from the wristband 1 is extended by several seconds, better both displaying and improving the warning effect of the special 3D embossed concave and convex pattern or text 10 and the bright colors, and as a result of the light source's projection a three-dimensional perspective effect is achieved, making the wristband 1 both more distinctive and improving its warning effect when in use.

The invention has the following advantages as can be seen from the foresaid description.

1. When the invention is worn when exercising at night, the vibrations will cause the lighting unit 2 to serve as a sufficient warning light, with the illumination-extending design of the light unit 2 increasing its usefulness.

2. The surface of the wristband 1 in the invention has a 3D embossed concave and convex pattern or text 10 and bright colors, with the illumination-extending design of the IC board 21 in the light unit 2 allowing the distinctiveness of the 3D embossed concave and convex pattern or text 10 on the wristband 1 more easily be clearly displayed as a result of the light source's projection achieving a three-dimensional perspective effect.

While the preferred embodiment of the invention has been described above, it will be recognized and understood that various modifications may be made therein and the appended claims are intended to cover all such modifications that may fall within the spirit and scope of the invention.

What is claimed is:

1. An exercise wristband that can extend illumination time, primarily comprising:
a wristband, made of flexible and translucent material, the surface of which has a three-dimensional (3D) embossed concave and convex design, and the underside of which has and insertion slot and cover;
a lighting unit, fit within the insertion slot on the wristband, and which includes a light component, Integrated Circuit board (IC board), highly sensitive vibration switch, and battery, wherein the light component and vibration switch are integrated on the IC board, and the IC board is design with a circuit that extends illumination time; and
the combination of the aforementioned components can provide a warning wristband with extended illumination time, while also allowing others to more clearly see the 3D embossed text or pattern on the wristband.

2. The exercise wristband that can extend illumination time as claimed in claim 1, wherein said light component is comprised of one or more light emitting diodes (LEDs), and which fluctuates between different colors.

3. The exercise wristband that can extend illumination time as claimed in claim 1, wherein the concave and convex of the surface of said wristband can be printed with a pattern or special text.

4. The exercise wristband that can extend illumination time as claimed in claim 1, wherein the concave and convex surface of said wristband can be printed with a pattern or special text can be printed with special colors.
